(19) United States
(12) Patent Application Publication
(10) Pub. No.: US 2008/0069765 A1
(43) Pub. Date: Mar. 20, 2008

(54) Catalyst configuration and methods for syngas production

(76) Inventors: Weibin Jiang, Clinton, NJ (US); Satish Tamhankar, Scotch Plains, NJ (US)

Correspondence Address: THE BOC GROUP, INC., 575 MOUNTAIN AVENUE, MURRAY HILL, NJ, 07974-2064, US

(21) Appl. No.: 11/523,360

(22) Filed: Sep. 19, 2006

(51) Int. Cl. C01B 3/26

(52) U.S. Cl. 423/651

(57) ABSTRACT

An improved process for the catalytic partial oxidation of hydrocarbons to produce hydrogen and carbon monoxide is disclosed. The process also utilizes a novel catalyst configuration apparatus containing a first stage reactor which contains a first layer of a noble or transition metal catalyst on a support and a second layer of a reduced metal catalyst supported on or in a stable inorganic metal oxide washcoated on a support, and a second stage reactor which is a shift reactor.

### BACKGROUND OF THE INVENTION

The conversion of hydrocarbons to hydrogen and carbon monoxide containing gases is well known in the art. Examples of such processes include catalytic steam reforming, auto-thermal catalytic reforming, catalytic partial oxidation and non-catalytic partial oxidation. Each of these processes has advantages and disadvantages and produces various ratios of hydrogen and carbon monoxide, also known as synthesis gas (syngas). The present invention is directed to a catalytic partial oxidation process.

Partial oxidation processes are also well known and the art is replete with various catalytic partial oxidation processes. Partial oxidation is an exothermic reaction wherein a hydrocarbon gas, such as methane, and an oxygen-containing gas, such as air, is contacted with a catalyst at elevated temperatures to produce a reaction product containing high concentrations of hydrogen and carbon monoxide. The catalysts used in these processes are typically noble metals, such as platinum or rhodium, and other transition metals, such as nickel, all on a suitable support.

Partial oxidation processes convert hydrocarbon-containing gases, such as natural gas to hydrogen, carbon monoxide and other trace components such as carbon dioxide and water. The process is typically carried out by injecting preheated hydrocarbons and an oxygen-containing gas into a combustion chamber where oxidation of the hydrocarbons occurs with less than stoichiometric amounts of oxygen for complete combustion. This reaction is conducted at very high temperatures, such as in excess of 700° C. and often in excess of 1,000° C., and pressures up to 150 atmospheres. In some reactions, steam or carbon dioxide can also be injected into the combustion chamber to modify the synthesis gas product and to adjust the ratio of hydrogen to carbon monoxide.

More recently, partial oxidation processes have been disclosed in which the hydrocarbon gas is contacted with the oxygen-containing gas at high space velocities in the presence of a catalyst such as a metal deposited on a ceramic monolith (e.g. foam or honeycomb) support. The monolith supports are impregnated with a noble metal such as platinum, palladium or rhodium, or other transition metals such as nickel, cobalt, chromium and the like. Typically, these monolith supports are prepared from solid refractory or ceramic materials such as alumina, zirconia, magnesia and the like. During operation of these reactions, the hydrocarbon feed gases and oxygen-containing gases are initially contacted with the metal catalyst at temperatures in excess of 400° C., typically in excess of 600° C., and at a standard gas hourly space velocity (GHSV) of over 100,000 per hour.

The partial oxidation of methane and other hydrocarbons is exothermic and under ideal conditions can proceed according to the stoichiometry of equation 1 to yield a syngas mixture with an H₂:CO ratio of 2:1 and equilibrium temperature less than 1100° C.

CH₄+½O₂→CO+2H₂ (1)

It has also been suggested that in catalytic partial oxidation bed, that the partial oxidation occurs in the first few millimeters of bed length. See Hickman and Schmidt, Syngas Gas Formation by Direct Oxidation of Methane Over Pt Monoliths, 138 J. Catalysis 267, 275 (1992). Therefore it is logically thought that only a small portion of the catalyst bed is needed to catalyze the reaction.

However we discovered that the actual temperature in the first few millimeters of the catalyst during a catalytic partial oxidation is much higher than expected. It has been found that nearly complete oxygen conversion is achieved in the first few millimeters of the catalyst and reaction performance improves when the length of the catalyst bed is increased.

Based on the above observations, it appears that direct partial oxidation is a combined effect of combustion, partial oxidation, steam and CO₂ reforming and water gas shift reaction. In the front of the reaction zone where feed gas contacts catalyst first, possibly only in the first few millimeters, oxidation reactions such as combustion, shown in equation 2, and partial oxidation, as in equation 1, compete with each other, leading to almost complete oxygen conversion.

CH₄+2O₂→CO₂+2H₂O (2)

Heat released by the exothermic oxidation reaction provides enough energy to further convert the unreacted hydrocarbon species with steam or CO₂ produced from combustion reaction to syngas, through endothermic steam and CO₂ reforming reactions (3) and (4) together with some water-gas shift or reverse water-gas shift reactions (5).

CH₄+H₂O→CO+3H₂ (3)

CH₄+CO₂→2CO₂+2H₂ (4)

H₂O+CO [symbol] CO₂+H₂ (5)

This explains the excess amount of heat at the front of the reaction zone, of more than 1450° C., causing extreme high temperature in the front layer. The endothermic nature of the reforming reaction rapidly cools the subsequent catalyst to less than 1100° C. As a result, the catalyst zone temperature is extremely high in the front layer followed by lower temperatures downstream.

A significant problem can arise in the operation of partial oxidation processes when using a reticulate monolithic catalyst at such high temperatures of more than 1450° C., where we discovered that reticulate monolith supports, such as those made of partially stabilized zirconia (PSZ) or Al₂O₃, are very susceptible to high temperatures and thermal shock, and ultimately lead to catalyst instability and brittleness after reaction. There are several potential reasons attributed to brittleness of reticulate monolith: hollow web-type structure is inherently weak at high temperature, phase transition of PSZ material and so on. However when the reaction temperature is controlled at less than 1100° C., reticulate monolith supports such as partially stabilized zirconia (PSZ) or Al₂O₃ can maintain their mechanical strength and give excellent reaction performance.

It has been found that the most suitable fixed arrangement for the catalyst for use in the catalytic partial oxidation of hydrocarbons under conditions which would be commercially attractive is one in which the catalyst is retained in the form of reticulate monolithic structure. Catalysts for use in such a process comprise one or more catalytically active components supported on a refractory oxide carrier, the carrier being in the form of a reticulate monolith.

However, it has now been found that problems can occur in the operation of the partial oxidation process when using a reticulate monolithic catalyst. In particular, it has been found that the refractory monolithic catalyst structures are very susceptible to thermal shock and high temperature prevailing in the catalytic partial oxidation process, causing brittleness of the structure and ultimately leading to catalyst disintegration, especially when using oxygen rather than air. Accordingly, it is an objective of the present invention to provide a catalytic partial oxidation process, which combines a partial oxidation reactor stage 1 with a shift reactor stage 2 to achieve catalyst long-term stability.

### SUMMARY OF THE INVENTION

The present invention provides for a method for the partial oxidation of hydrocarbons to produce hydrogen and carbon monoxide by contacting with a mixture of a hydrocarbon-containing feed gas and an oxygen-containing gas a two stage reactor comprising a first stage reactor which comprises a catalyst composition of a first layer of a catalytically active metal dispersed on an inert carrier support and a second layer of a reduced metal catalyst consisting essentially of a transition metal supported on or in a stable inorganic metal oxide washcoated on a support, and a second stage reactor comprising a shift reactor. The present invention further provides for an apparatus that comprises the first stage reactor and the second stage reactor.

The second stage reactor is a shift reactor and can be selected from the group consisting of catalytic monolith and a shift catalyst. The catalytic monolith can be a metal catalyst consisting essentially of a metal supported by a ceria coating disposed on a ceramic monolith; wherein the metal is selected from at least one of nickel, cobalt, iron, platinum, palladium, iridium, rhenium, ruthenium, rhodium and osmium; the ceramic is selected from at least one of zirconia, alumina, yttria, titania, magnesia, ceria and cordierite; and the ceria coating has a weight percent between about 5% and about 30% with respect to the ceramic monolith. In one embodiment, the ceramic is selected from at least one of zirconia, yttria, titania, magnesia, ceria and cordierite.

The shift catalyst in the second reactor can be a low temperature shift catalyst or water gas shift reactor catalyst.

The hydrocarbons that are employed in the feed gas are typically alkanes having from 1 to about 4 carbon atoms. Most preferably, the hydrocarbon is selected from the group consisting of natural gas and methane.

### BRIEF DESCRIPTION OF THE DRAWINGS

FIG. 1 is a schematic of the integrated two stage reactor of the present invention.

FIG. 2 is a schematic process scheme using the two stage reactor of the present invention.

FIG. 3 is an alternative schematic process scheme using the two stage reactor of the present invention.

### DETAILED DESCRIPTION OF THE INVENTION

The present invention provides for methods for the partial oxidation of hydrocarbons to produce hydrogen and carbon monoxide or syngas from a mixture of a hydrocarbon-containing feed gas stream and an oxygen-containing feed gas stream using a two stage reactor system.

The first stage reactor is a catalyst composition which has two layers. The first layer is a catalytically active metal dispersed on an inert carrier support. The second layer is a reduced metal catalyst which consists essentially of a transition metal supported on or in a stable inorganic metal oxide washcoated on a support. The second stage reactor comprises a shift reactor. For purposes of the present invention, the shift reactor can be catalytic monolith or a shift reactor such as a low temperature shift catalyst or water gas shift catalyst. The hydrocarbon and oxygen containing gas streams are fed to this two-stage reactor and will react to form the hydrogen carbon monoxide or syngas.

The present invention also provides for a reactor system apparatus which is used in the partial oxidation of hydrocarbons to produce hydrogen and carbon monoxide or syngas which comprises a two stage reactor system.

The first stage comprises a catalyst composition of two layers. The first layer being a catalytically active metal dispersed on an inert carrier support and the second layer is a reduced metal catalyst consisting essentially of a transition metal supported on or in a stable inorganic metal oxide washcoated on a support.

The second stage reactor in the reactor system comprises a shift reactor. The shift reactor may be selected from a catalytic monolith or a low temperature shift catalyst or water gas shift catalyst. The catalytic monolith which may be used in the second stage reactor, is a metal catalyst which consists essentially of a metal supported by a ceria coating disposed on a ceramic monolith. The metal is selected from the group consisting of nickel, cobalt, iron, platinum, palladium, iridium, rhenium, ruthenium, rhodium, and osmium. The ceramic material is selected from the group consisting of zirconia, alumina, yttria, titania, magnesia, ceria, and cordierite. The ceria coating has a weight percentage between about 5% and about 30% with respect to the ceramic monolith. In one embodiment of the monolith catalyst, the ceramic is selected from the group consisting of zirconia, yttria, titania, magnesia, ceria, and cordierite.

A further description of this metal catalyst monolith ceramic may be found in co-pending application Ser. No. 10/143,705 published Jan. 9, 2003 as US 2003/0007926 A1 to Jiang et al.

In a preferred embodiment of the catalytic monolith, a zirconium monolith is coated by about 1 to 20 weight percent of ceria which supports 0.5 to 5 weight percent rhodium on the ceria-coated monolith.

The apparatus for the partial oxidation of hydrocarbons to produce hydrogen and carbon monoxide comprising a first stage reactor which comprises a catalyst composition of a first layer of a catalytically active metal dispersed on an inert carrier support and a second layer of a reduced metal catalyst consisting essentially of a transition metal supported on or in a stable inorganic metal oxide washcoated on a support, and a second stage reactor comprising a shift reactor.

The preferred catalyst substrates to use in the first layer at the feed side are particulates including spheres, pellets and rings; wagonwheels, Saint-Gobain Norpro's Ty-Pak®, HexPak™, Snowflake® media, and Norton® saddles, gauze wire, honeycomb monoliths or any other suitable supports in any acceptable manufactured shapes such as those listed herein, although reticulated monoliths with improved mechanical strength can also be used. This mechanical strength can be illustrated for purposes of the present invention as “crush strength” which is the maximum stress that a material can sustain under crush loading. The crush loading is that weight and/or pressure that will fracture or compact the catalyst substrate. The catalyst substrates of the present invention will have a crush strength that can withstand the typical operating conditions of a partial oxidation process of hydrocarbons. Accordingly the catalyst substrates of the present invention will not lose crush strength during the normal operation of a partial oxidation process for hydrocarbons. The layered catalysts at the product side may catalyze the partial oxidation, but mainly promote reforming and water-gas shift reactions to achieve high level of carbon conversion with high syngas selectivity. The reticulated monoliths are more suitable for these subsequent layers, particularly as the last layer.

When more than two layers are used, they can be layered in any order provided the first layer is more stable to thermal shock and higher temperatures in excess of 1100° C. and the subsequent layers can further catalyze the subsequent carbon conversion to syngas. The pore structure of monoliths and the particle size of particulates are such that there is no significant pressure drop through the bed. US 2003/0083198 A1 teaches a fixed bed catalyst system comprising first and second zones disposed in stacked serial flow arrangement in order to achieve better flow distribution, where first zone (upstream section) has a greater resistance to flow of the feed stream than second zone (down stream section). However, in the current invention, the first layer (upstream) can be less resistant than the second layer by using a larger pore size honeycomb rather than a reticulate monolith. A catalytically inactive substrate may be placed between each of the catalyst layers to improve the gas distribution.

Protection of the reticulated monolith catalyst either from active metal sintering or mechanical strength weakening at high temperatures can be achieved by shielding it from the high temperature using the first layer as the combustion catalyst. This concept of multi-layer catalysts is shown in the following drawing, where NG stands for natural gas.

The first layer catalyst desirably should be able to operate in an oxidizing and reducing environment effectively without significant deactivation over a temperature range from about 1000° to about 1800° C. The first layer catalyst preferably comprises catalytically active metals dispersed on an inert carrier support. The metals used in the present catalysts are selected from certain transition and noble metals of the Periodic Table of Elements. Active metals can be selected from the group consisting of transition or noble metal selected from the group of nickel, cobalt, iron, platinum, palladium, iridium, rhenium, ruthenium, rhodium and osmium and combinations thereof. Preferred metals are nickel and rhodium.

The most preferred metal of this group is rhodium. The metals may be present on the support in the form of metals, metal oxides, metal halides or other metal salts prior to being reduced. Upon reduction, as described below, the metals are substantially in the metallic form. Generally, from about 0.1% to 8% by weight of the metal will be deposited on the support. Optionally Rh/Pt gauze catalyst can be used as the exothermic reaction catalyst.

US 2003/0198592 A1 discloses multiple serially aligned reaction zones and multiple hydrocarbon feeds for converting a hydrocarbon and oxygen feed stream to syngas. The first reaction zone catalyzes the net partial oxidation of the feed hydrocarbon and the subsequent zone catalyzes either a water-gas shift reaction, net partial oxidation, steam or dry reforming. Some of the most selective catalysts, such as Rh, are not able to withstand the heat and retain their activity due to problems such as sintering and a limited tolerance to carbon formation. The present invention provides an advantage inasmuch as it places more of a thermally stable catalyst, such as a mixed metal oxide or a stable crystalline structure such as a spinel or perovskite, more preferably CoCrOxide, at the front of the reactor and most preferably 9.9 wt % Co_{0.2}Cr_{0.8}Oxide/1 wt % Rh/6.1 wt % Yb supported on a refractory support such as alumina or zirconia, preferably partially stabilized zirconia (PSZ).

In the process of the present invention, the exothermic reaction is almost complete instantaneously after contacting the first catalyst layer. The primary function of subsequent layer is to effect the endothermic reforming reaction. The “net partial oxidation” catalyst zone is considered as the two layers comprising a combustion catalyst and an endothermic catalyst. It is important to point out that PSZ reticulate material is not preferred due to the inherent phase transition at high temperature and clearly Rh coating on Al₂O₃ is stable even after more than 7 months of continuous operation as the first layer. It retains its catalytic activity as well as its mechanical strength.

A preferred form of inert carrier is made of a refractory, substantially inert, rigid material which is capable of maintaining its shape with sufficient degree of mechanical strength at high temperatures. Typically, a material is selected for the support, which exhibits a low thermal coefficient of expansion, good thermal shock resistance and high melting point. For example, cordierite material is not suitable as the front layer support for pure oxygen-based partial oxidation due to its lower melting point around 1450° C.

Several general types of material for construction of such carriers are known. Honeycomb monolithic supports are commercially available in various sizes and configuration. A suitable shape and size of pellet or granule type catalyst can also be purchased commercially. Both types of support structures are made from conventional refractory or ceramic materials selected from the group consisting of alumina, mullite, zirconia, partially stabilized zirconia, ceria, silica, silicon carbide, silicon nitride, Sialon™ (a silicon nitride ceramic with a small percentage of aluminum oxide added), aluminum nitride, boron nitride, aluminosilicate, magnesium aluminosilicates, and mixtures of these. Carriers can be formed by any suitable process, including molding, pressing, extruding, spray drying or die stamping, and so on. Inert support also includes metal monolith, prepared as metal foam or sintered particles of metal at high temperature. The most preferred support is a stabilized alumina, silicon carbide or partially stabilized zirconia in the form of honeycomb, sphere, pellet, ring, wagonwheel, Saint-Gobain Norpro's Ty-Pak®, HexPak™, Snowflake® media and Norton® saddles or granule. Preferably the surface area of support is relatively low ranging from between about 0.1 and about 50 m²/g.

Subsequent Catalyst Layer

The subsequent catalyst layer beneath the first layer desirably should be able to operate in oxidizing and reducing environments effectively without significant deactivation over a temperature range below about 1100° C. The endothermic reaction catalyst comprises any of the catalytic metal catalysts known for such purpose. The metal catalysts employed in the present invention are monolith support structures composed primarily of partially stabilized zirconia washcoated with cerium oxide and impregnated with a noble or transition metal or combinations thereof. As used herein, “metal catalyst” refers to the entire catalyst structure including the metal, inorganic metal oxide washcoat and the monolith support or monolith substrate. The active metals used in the present catalysts are selected from the group consisting of a transition or noble metal selected from the group of nickel, cobalt, iron, platinum, palladium, iridium, rhenium, ruthenium, rhodium and osmium and combinations thereof. Preferably the active metals are rhodium and/or nickel.

A monolith support is generally a ceramic foam-like or porous structure formed from a single structural unit having passages disposed in either an irregular or regular pattern with spacing between adjacent passages. Preferred are the ceramic foam structures having irregular passages. The support structures are made from conventional refractory or ceramic materials selected from the group consisting of alumina, mullite, zirconia, partially stabilized zirconia, ceria, silica, silicon carbide, silicon nitride, Sialon™, a silicon nitride ceramic with a small percentage of aluminum oxide added, aluminum nitride or boron nitride, aluminosilicate, magnesium aluminosilicates, and mixtures of these. Metal monoliths prepared as metal foams can also be used. The most preferred supports are partially stabilized zirconia or silicon carbide.

It is preferred to incorporate the active metals on a high surface area for improved overall catalyst effectiveness and activity. The surface area of the support can be increased by depositing a high-surface area inorganic metal oxide such as gamma alumina, ceria, etc. by impregnation, washcoating, adsorption, ion-exchange, precipitation, co-precipitation, deposition precipitation, sol-gel method, slurry dip-coating, microwave heating, etc. Processes for coating substrates with inorganic metal oxides comprise contacting a substrate with a metal oxide precursor, preferably maintaining the precursor coated substrate at conditions to equilibrate the coating, and then oxidizing the precursor to form a substrate containing metal oxide. It is preferred to have macropores by adding decomposable organic matter to the washcoat and then decomposing it at high temperatures in an oxidizing atmosphere.

The stable high surface area inorganic oxides that can be washcoated are selected from but are not limited to oxides comprising one or more cations selected from groups IA, IIA, IIIA and IVA of the Periodic Table of the Elements and the transition metals, preferably from groups IA, IIA, IIIA, IIIB, IVA, IVB and the lanthanides, more preferably from ceria, aluminum, lanthanum, zirconium and barium and mixtures of these. The foam may be impregnated with more than one inorganic oxide simultaneously or sequentially.

Suitably the impregnating medium is in the form of an aqueous or organic solution, slurry, sol, gel, suspension or dispersion of inorganic oxide(s) particles, preferably of a sol of colloidal inorganic oxide(s) particles. The precursors of these washcoats are in any form that can be decomposed to an oxide by thermal decomposition. A stabilizing agent such as an oxide of alkaline or rare earth oxide may be added to the washcoat to prevent the sintering of washcoat during the reaction or pretreatment.

The most preferred support is a partially stabilized zirconia foam monolith washcoated with about 5% to about 30% inorganic metal oxide, most preferably ceria. Optionally ceramic honeycomb or metal monolith coated with noble metal can also be used as endothermic reaction catalyst.

In one aspect, the invention provides a process for the partial oxidation of hydrocarbons to produce hydrogen and carbon monoxide comprising contacting a mixture of a hydrocarbon-containing feed gas and an oxygen-containing feed gas with a catalytically effective multi-layer configuration, at a pressure between 1 and 20 atmospheres, a feed gas standard gas hourly space velocity of about 5,000 to about 500,000 per hour, and a linear velocity of about 0.2 to about 50.0 meter per second (mls). In addition, the feed gas mixture may also comprise steam and/or CO₂. The two stages of the reactor apparatus will operate at different temperatures with the first stage operating at about 800° to about 100° C. and the second stage operating at about 250° to about 600° C. The reactant gas mixture can also be preheated to a temperature of about 10 to about 450° C.

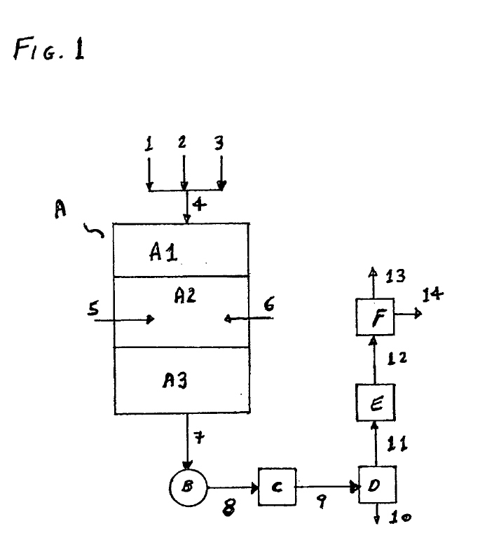

Turning now to the figures, FIG. 1 is a schematic diagram of the integrated two stage reactor of the present invention. Lines 1, 2, and 3 allow for the feed, respectively, of steam, natural gas, and oxygen and enter through line 4 into the integrated two stage reactor A. A1 is the first stage reactor and the feed gas streams will flow through the two layers of catalytic material present therein. These gas streams will continue into A2 where water quench is entered through line 5 as well as steam through line 6. The now quenched gas stream will continue on into section A3 which is the shift reactor and will exit the two stage reactor through line 7 and enter a cooling unit B. The shift reactor can be operated in a more efficient manner by adjusting the steam to carbon ratio entering the second stage reactor. The now cooled product stream will exit through line 8 to a further low temperature shift reactor C. The gas stream exits through line 9 to a condensing unit D where water present in the product gas stream will condense out. The water free gas stream then travels through line 11 through a compression unit E, then through line 12 to a separation unit F. This separation unit can be a pressure swing adsorption system or a membrane system and this will separate out the hydrogen product which will exit through line 13. The remainder will exit through line 14 and consists primarily of carbon monoxide.

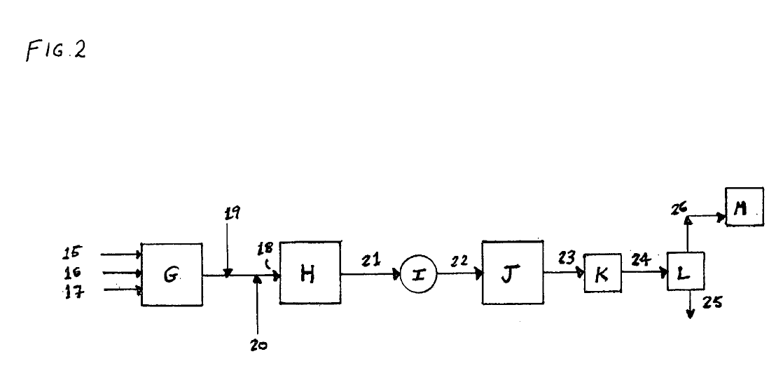

FIG. 2 is a schematic of the overall process of the present invention. Oxygen, natural gas, and steam will enter, respectively, through lines 15, 16, and 17 into the first stage reactor G. The product gas stream from the first stage reactor will exit through line 18 where both water and steam are entered into the line 18 through lines 19 and 20, respectively, prior to the gas stream entering the second stage reactor H. The product gas stream which consists primarily of hydrogen, carbon monoxide, and carbon dioxide, will exit the second stage reactor through line 21 and go through a heat exchanger or cooling unit 1. The now cooled product gas stream exits the heat exchanger through line 22 to enter a low temperature shift reactor J. The low temperature shift reactor further drives the remaining hydrocarbon and carbon monoxide further into producing hydrogen, which will exit through line 23 through a syngas compressor K and the product gas stream exits the compressor through line 24 into a gas separation unit L which can be a pressure swing adsorption unit or a membrane system which will separate the product gas stream into hydrogen which exits through line 26 to storage M and tail gas fuel which will exit through line 25.

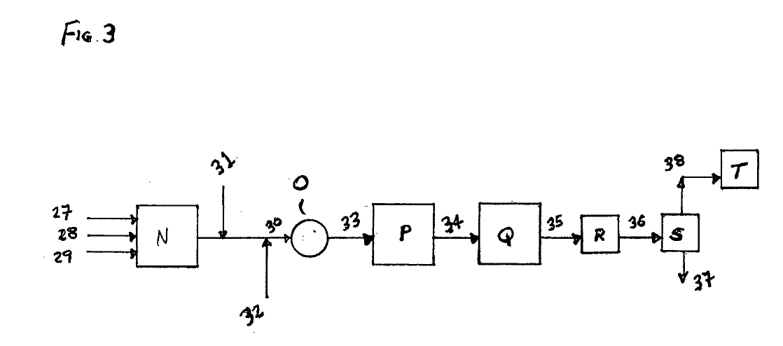

In FIG. 3, oxygen, natural gas, and steam will enter through lines 27, 28, and 29, respectively, into the first stage monolith reactor N. The product stream from the first stage reactor will exit through line 30 where water and steam are directed into the line 30 through lines 31 and 32. A heat exchanger or cooling unit O then receives the gas stream and the now cooled gas stream is directed through line 33 into the second stage reactor. The product stream, which now consists primarily of hydrogen and carbon monoxide, some carbon dioxide, is directed through line 35 to a syngas compressor R and the compressed gas stream exits through line 36 to a gas separation system which can be a pressure swing adsorption unit or a membrane system S. Tail gas will exit through line 37 and the hydrogen product can be recovered through line 38 and stored in T.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

Having thus described the invention, what we claim is:

1. A method for the partial oxidation of hydrocarbons to produce hydrogen and carbon monoxide by contacting with a mixture of a hydrocarbon-containing feed gas and an oxygen-containing gas a two stage reactor comprising a first stage reactor which comprises a catalyst composition of a first layer of a catalytically active metal dispersed on an inert carrier support and a second layer of a reduced metal catalyst consisting essentially of a transition metal supported on or in a stable inorganic metal oxide washcoated on a support, and a second stage reactor comprising a shift reactor.

2. The method as claimed in claim 1 wherein said catalytically active metal is selected from the group consisting of nickel, cobalt, iron, platinum, palladium, iridium, rhenium, ruthenium, rhodium, osmium and combinations thereof.

3. The method as claimed in claim 2 wherein said catalytically active metal is selected from the group consisting of rhodium and nickel.

4. The method as claimed in claim 3 wherein said catalytically active metal is rhodium.

5. The method as claimed in claim 1 wherein said catalytically active metal is deposited on said inert carrier support in an amount ranging from about 0.1% to about 8.0% by weight.

6. The method as claimed in claim 1 where said inert carrier support has a shape selected from the group consisting of honeycomb, sphere, pellet, ring, wagonwheel, saddles, and granule.

7. The method as claimed in claim 6 wherein said inert carrier support is a monolithic support having a honeycomb shape.

8. The method as claimed in claim 7 wherein said honeycomb monolithic support is made from a material selected from the group consisting of alumina, mullite, zirconia, partially stabilized zirconia, ceria, silica, silicon carbide, silicon nitride, silicon nitride ceramic, aluminum nitride, boron nitride, aluminosilicate, magnesium aluminosilicates, a combination of magnesium aluminosilicates and aluminosilicate, and mixtures of these.

9. The method as claimed in claim 8 wherein said material is selected from the group consisting of alumina or partially stabilized zirconia.

10. The method as claimed in claim 1 wherein said inert carrier support has a surface area of about 0.10 to about 50.0 m²/g.

11. The method as claimed in claim 1 wherein said support is selected from the group consisting of a ceramic foam monolith, a honeycomb monolith, and a metal monolith.

12. The method as claimed in claim 1 wherein said support is ceria washcoated on partially stabilized zirconia monolith support.

13. The method as claimed in claim 12 wherein said ceria-washcoated partially stabilized zirconia monolith support contains about 5% to about 30% ceria by weight.

14. The method as claimed in claim 1 wherein said transition metal is selected from the group consisting of nickel, cobalt, iron, platinum, palladium, iridium, rhenium, ruthenium, rhodium, osmium, and combinations thereof.

15. The method as claimed in claim 14 wherein said transition metal is selected from the group consisting of rhodium, nickel and a mixture of rhodium and nickel.

16. The method as claimed in claim 1 wherein said transition metal is about 2 to about 4 percent by weight of said monolith support.

17. The method as claimed in claim 1 wherein said stable inorganic metal oxide is selected from to the group of oxides comprising one or more cations selected from groups IA, IIA, IIIA and IVA of the Periodic Table of the Elements, the transition metals and mixtures of these.

18. The method as claimed in claim 17 wherein said cation is selected from the group consisting of ceria, aluminum, lanthanum, zirconium and barium and mixtures of these.

19. The method as claimed in claim 18 wherein said cation is ceria.

20. The method as claimed in claim 1 wherein said inorganic metal oxide is about 5 to about 30 percent by weight of said monolith support.

21. The method as claimed in claim 17 wherein said stable inorganic metal oxide comprises an additional stabilizing agent selected from the group consisting of an oxide of alkaline or rare earth oxide, thereby inhibiting the sintering of washcoat during reaction or pretreatment of said support.

22. The method as claimed in claim 17 wherein said ceramic foam monolith support is made from a material selected from the group consisting of alumina, mullite, zirconia, partially stabilized zirconia, ceria, silica, silicon carbide, silicon nitride, silicon nitride ceramic, aluminum nitride, boron nitride, aluminosilicate, magnesium aluminosilicates, a combination of magnesium aluminosilicates and aluminosilicate, and mixtures of these.

23. The method as claimed in claim 22 wherein said material is selected from the group consisting of partially stabilized zirconia or silicon carbide.

24. The method as claimed in claim 1 wherein said second stage reactor is selected from the group consisting of a catalytic monolith and a shift reactor.

25. The method as claimed in claim 24 wherein said catalytic monolith consists essentially of a metal supported by a ceria coating disposed on a ceramic monolith; wherein said metal is selected from at least one of nickel, cobalt, iron, platinum, palladium, iridium, rhenium, ruthenium, rhodium and osmium; said ceramic is selected from at least one of zirconia, yttria, titania, magnesia, ceria and cordierite; and said ceria coating has a weight percent between about 5% and about 30% with respect to said ceramic monolith.

26. The method as claimed in claim 25 wherein said weight percent of said ceria coating is between about 10% and about 20% with respect to said ceramic monolith.

27. The method as claimed in claim 25 wherein said metal is present in an amount between about 0.2% and about 5% by weight with respect to said ceramic monolith.

28. The method as claimed in claim 25 wherein said ceramic monolith has a porosity between about 10 and about 100 pores per inch.

29. The method as claimed in claim 25a wherein said metal is selected from the group consisting of nickel, platinum, palladium and rhodium, and said ceramic is zirconia.

30. The method as claimed in claim 25 wherein a porous material layer is disposed between said ceria coating and said ceramic monolith.

31. The method as claimed in claim 1 further comprising a heat exchanger being present between said first stage reactor and said second stage reactor.

32. The method as claimed in claim 1 further comprising a heat exchanger being present after said first stage reactor and said second stage reactor.

33. An apparatus for the partial oxidation of hydrocarbons to produce hydrogen and carbon monoxide by contacting with a mixture of a hydrocarbon-containing feed gas and an oxygen-containing gas comprising a first stage reactor which comprises a catalyst composition of a first layer of a catalytically active metal dispersed on an inert carrier support and a second layer of a reduced metal catalyst consisting essentially of a transition metal supported on or in a stable inorganic metal oxide washcoated on a support, and a second stage reactor comprising a shift reactor.

34. The apparatus as claimed in claim 33 wherein said catalytically active metal is selected from the group consisting of nickel, cobalt, iron, platinum, palladium, iridium, rhenium, ruthenium, rhodium, osmium and combinations thereof.

35. The apparatus as claimed in claim 34 wherein said catalytically active metal is selected from the group consisting of rhodium and nickel.

36. The apparatus as claimed in claim 35 wherein said catalytically active metal is rhodium.

37. The apparatus as claimed in claim 33 wherein said catalytically active metal is deposited on said inert carrier support in an amount ranging from about 0.1% to about 8.0% by weight.

38. The apparatus as claimed in claim 33 where said inert carrier support has a shape selected from the group consisting of honeycomb, sphere, pellet, ring, wagonwheel, saddles, and granule.

39. The apparatus as claimed in claim 38 wherein said inert carrier support is a monolithic support having a honeycomb shape.

40. The apparatus as claimed in claim 39 wherein said honeycomb monolithic support is made from a material selected from the group consisting of alumina, mullite, zirconia, partially stabilized zirconia, ceria, silica, silicon carbide, silicon nitride, silicon nitride ceramic, aluminum nitride, boron nitride, aluminosilicate, magnesium aluminosilicates, a combination of magnesium aluminosilicates and aluminosilicate, and mixtures of these.

41. The apparatus as claimed in claim 40 wherein said material is selected from the group consisting of alumina or partially stabilized zirconia.

42. The apparatus as claimed in claim 33 wherein said inert carrier support has a surface area of about 0.10 to about 50.0 m²/g.

43. The apparatus as claimed in claim 33 wherein said support is selected from the group consisting of a ceramic foam monolith, a honeycomb monolith, and a metal monolith.

44. The apparatus as claimed in claim 33 wherein said support is ceria washcoated on partially stabilized zirconia monolith support.

45. The apparatus as claimed in claim 44 wherein said ceria-washcoated partially stabilized zirconia monolith support contains about 5% to about 30% ceria by weight.

46. The apparatus as claimed in claim 33 wherein said transition metal is selected from the group consisting of nickel, cobalt, iron, platinum, palladium, iridium, rhenium, ruthenium, rhodium, osmium, and combinations thereof.

47. The apparatus as claimed in claim 46 wherein said transition metal is selected from the group consisting of rhodium, nickel and a mixture of rhodium and nickel.

48. The apparatus as claimed in claim 33 wherein said transition metal is about 2 to about 4 percent by weight of said monolith support.

49. The apparatus as claimed in claim 33 wherein said stable inorganic metal oxide is selected from to the group of oxides comprising one or more cations selected from groups IA, IIA, IIIA and IVA of the Periodic Table of the Elements, the transition metals and mixtures of these.

50. The apparatus as claimed in claim 49 wherein said cation is selected from the group consisting of ceria, aluminum, lanthanum, zirconium and barium and mixtures of these.

51. The apparatus as claimed in claim 50 wherein said cation is ceria.

52. The apparatus as claimed in claim 33 wherein said inorganic metal oxide is about 5 to about 30 percent by weight of said monolith support.

53. The apparatus as claimed in claim 52 wherein said stable inorganic metal oxide comprises an additional stabilizing agent selected from the group consisting of an oxide of alkaline or rare earth oxide, thereby inhibiting the sintering of washcoat during reaction or pretreatment of said support.

54. The apparatus as claimed in claim 52 wherein said ceramic foam monolith support is made from a material selected from the group consisting of alumina, mullite, zirconia, partially stabilized zirconia, ceria, silica, silicon carbide, silicon nitride, silicon nitride ceramic, aluminum nitride, boron nitride, aluminosilicate, magnesium aluminosilicates, a combination of magnesium aluminosilicates and aluminosilicate, and mixtures of these.

55. The apparatus as claimed in claim 54 wherein said material is selected from the group consisting of partially stabilized zirconia or silicon carbide.

56. The apparatus as claimed in claim 33 wherein said first and said second layers are serially aligned.

57. The apparatus as claimed in claim 33 comprising at least one of said first layer and at least one of said second layer.

58. The apparatus as claimed in claim 33 further comprising a catalytically inactive substrate between said first layer and said second layer.

59. The apparatus as claimed in claim 33 wherein said catalytic monolith consists essentially of a metal supported by a ceria coating disposed on a ceramic monolith; wherein said metal is selected from at least one of nickel, cobalt, iron, platinum, palladium, iridium, rhenium, ruthenium, rhodium and osmium; said ceramic is selected from at least one of zirconia, yttria, titania, magnesia, ceria and cordierite; and said ceria coating has a weight percent between about 5% and about 30% with respect to said ceramic monolith.

60. The apparatus as claimed in claim 33 wherein said weight percent of said ceria coating is between about 10% and about 20% with respect to said ceramic monolith.

61. The apparatus as claimed in claim 33 wherein said metal is present in an amount between about 0.2% and about 5% by weight with respect to said ceramic monolith.

62. The apparatus as claimed in claim 33 wherein said ceramic monolith has a porosity between about 10 and about 100 pores per inch.

63. The apparatus as claimed in claim 33 wherein said metal is selected from the group consisting of nickel, platinum, palladium and rhodium, and said ceramic is zirconia.

64. The apparatus as claimed in claim 33 wherein a porous material layer is disposed between said ceria coating and said ceramic monolith.
